(19) United States
(12) Patent Application Publication
(10) Pub. No.: US 2007/0176378 A1
(43) Pub. Date: Aug. 2, 2007

(54) PLUMBERS HELPER

(76) Inventor: Frank R. Bangs, Canton, MA (US)

Correspondence Address: ADVANTIA LAW GROUP, 9035 SOUTH 1300 EAST, SUITE 200, SANDY, UT, 84094, US

(21) Appl. No.: 11/307,277

(22) Filed: Jan. 30, 2006

(51) Int. Cl. B25H 5/00

(52) U.S. Cl. 280/32.6

(57) ABSTRACT

A novel apparatus for at least carrying and supporting the lower back of a supine oriented user engaged in plumbing related activities, at least includes: a substrate member; a padding layer coupled to the substrate member and adapted to cushion the support of the user; and at least three caster wheel members coupled to the side of the substrate member opposite the side of the padding layer. The effective height of the apparatus is adapted to substantially match the height of vanity or kitchen cabinets.

### BACKGROUND OF THE INVENTION

1. Field of the Invention

The present invention relates to plumbing installation and repair accouterments.

2. Description of the Related Art

Many plumbing related repairs and tasks require plumbers or others carrying out the tasks to perform in tight spaces. As a result the tasks cannot often be carried out while standing naturally. Perhaps the most uncomfortable plumbing tasks requiring accessing pipes and plumbing accessories that are in cabinets and other tight spaces near floors, requiring the repairperson to assume prone or supine positions.

Supine positions during such task can cause pain and even injury because height differentials between the torso and lower extremities necessitated by raised ledges can lead to lower back stress. The ledges combined with the awkward orientation of the repairperson can also cause the ledges to impinge directly onto the repairperson's back.

The prior art contains many approaches for automotive repair in a supine position. These include mechanic's creepers and the like disclosed in the following U.S. Pat. Nos. and U.S. patent applications: 2005/0051980; 6,705,622; 5,611,552; Des. 408,110; 5,195,763; and 2,595,783. None of the cited references appears to be directed to plumbing. Additionally, the prior art does not appear to deliberately elevate the lower back to such small heights as five to eight inches above the ground to match the heights of cabinet ledges under sinks etc.

Therefore, what is needed but lacking, is an accessory for resting the back during supine plumbing tasks at a height of just a few inches above the ground to deliberate match cabinet ledge heights and eliminate back stress or injury.

### SUMMARY OF THE INVENTION

The present invention has been developed in response to the present state of the art, and in particular, in response to the problems and needs in the art that have not yet been fully solved. Accordingly, the present invention has been developed to provide a novel apparatus for at least carrying and supporting the lower back of a supine oriented user engaged in plumbing related activities, that at least includes: a substrate member; a padding layer coupled to the substrate member and adapted to cushion the support of the user; and at least three caster wheel members coupled to the side of the substrate member opposite the side of the padding layer. The effective height of the apparatus is adapted to substantially match the height of vanity or kitchen cabinets.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side view of the present-inventive apparatus for supporting the lower back of a repairperson during plumbing related activities;

FIG. 2 is a side view of an alternate embodiment of the apparatus of FIG. 1, wherein the height of the apparatus is adjustable, and wherein a first cabinet ledge height is matched; and

FIG. 3 is a side view of an alternate embodiment of the apparatus of FIG. 1, wherein the height of the apparatus is adjustable, and wherein a second cabinet ledge height is matched.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment, ” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

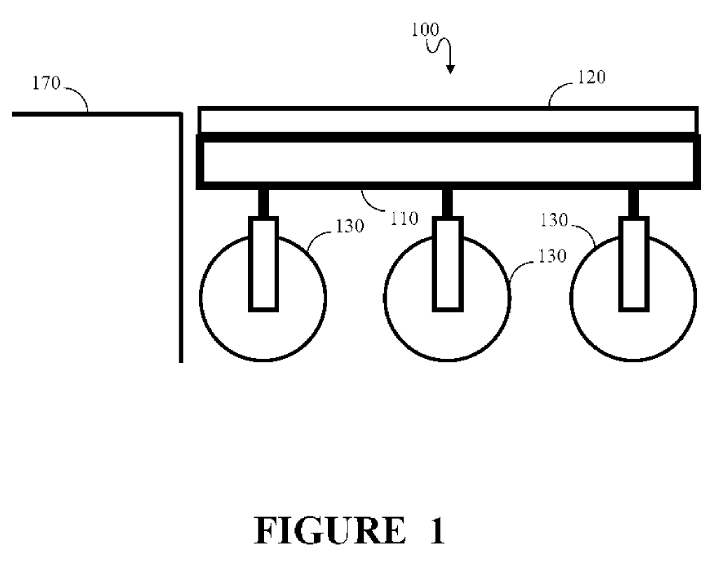

FIG. 1 illustrates the present-inventive apparatus 100 for supporting the lower back of a user in the supine position while the user is engaged in plumbing repair in a cabinet with a ledge 170. The apparatus 100 nominally includes a sturdy substrate 110 which is constructed of suitable material, including metal, strong plastic, wood, etc. Padding 120 is affixed to the substrate to provide extra comfort.

The substrate 110 is mounted on three or more swiveling caster wheels or casters 130 capable of allowing the apparatus 100 to be moved and maneuvered along a floor or the like, into a position next to a cabinet or sink ledge. The caster are capable of being locked to prevent rotation wheels one a desired floor position is reached.

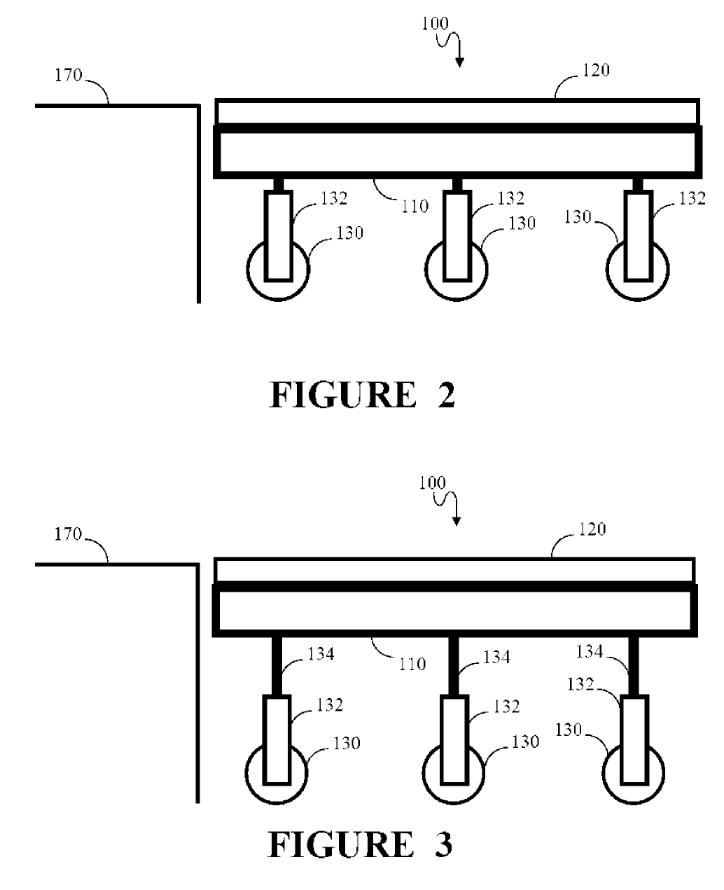

While the height of a typical vanity or sink cabinet (and hence the ledge 170 is approximately 5½ inches, those skilled the art to which the present invention pertains will understand that different heights may be needed for variations in cabinets. Therefore, an alternate embodiment for the apparatus is illustrated in FIGS. 2 and 3. The alternate embodiment includes casters 130 attached to the substrate 110 by adjustable height mechanisms consisting of posts 134 inserted into sleeves 132. Locking mechanisms (not shown) allow the adjusted height to be locked into place.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An apparatus for at least carrying and supporting the lower back of a supine oriented user engaged in plumbing related activities, said apparatus comprising:
a substrate member;
a padding layer coupled to said substrate member and adapted to cushion the support of said user; and
at least three caster wheel members coupled to the side of said substrate member opposite the side of said padding layer;
wherein the effective height of said apparatus is adapted to substantially match the height of vanity or kitchen cabinets.

2. The apparatus of claim 1, wherein said effective height is no more than seven (7) inches.

3. The apparatus of claim 1, wherein said caster wheel members may be locked to prevent undesired rolling.

4. The apparatus of claim 1, wherein the effective height of said apparatus is adjustable.

5. The apparatus of claim 2, wherein the effective height of said apparatus is adjustable.

6. An apparatus for at least carrying and supporting the lower back of a supine oriented user engaged in plumbing related activities, said apparatus consisting of:
a substrate member;
a padding layer coupled to said substrate member and adapted to cushion the support of said user; and
at least three caster wheel members coupled to the side of said substrate member opposite the side of said padding layer;
wherein the effective height of said apparatus is adapted to substantially match the height of vanity or kitchen cabinets.

7. The apparatus of claim 6, wherein said effective height is no more than seven (7) inches.

8. The apparatus of claim 6, wherein said caster wheel members may be locked to prevent undesired rolling.

9. The apparatus of claim 6, wherein the effective height of said apparatus is adjustable.

10. The apparatus of claim 7, wherein the effective height of said apparatus is adjustable.

11. An apparatus for at least carrying and supporting the lower back of a supine oriented user engaged in plumbing related activities, said apparatus consisting essentially of:
a substrate member;
a padding layer coupled to said substrate member and adapted to cushion the support of said user; and
at least three caster wheel members coupled to the side of said substrate member opposite the side of said padding layer;
wherein the effective height of said apparatus is adapted to substantially match the height of vanity or kitchen cabinets.

12. The apparatus of claim 11, wherein said effective height is no more than seven (7) inches.

13. The apparatus of claim 11, wherein said caster wheel members may be locked to prevent undesired rolling.

14. The apparatus of claim 11, wherein the effective height of said apparatus is adjustable.

15. The apparatus of claim 12, wherein the effective height of said apparatus is adjustable.
